(19) United States
(12) Patent Application Publication
(10) Pub. No.: US 2005/0215670 A1
(43) Pub. Date: Sep. 29, 2005

(54) Coating composition and article coated therewith

(76) Inventors: Akihiko Shimasaki, Kanagawa (JP); Hideki Iijima, Kanagawa (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/810,630

(22) Filed: Mar. 29, 2004

(51) Int. Cl. C08L 63/00

(52) U.S. Cl. 523/451

(57) ABSTRACT

A coating composition used for coating of a steel material and/or aluminum material comprises a corrosion inhibitor, a base resin and a curing agent. The corrosion inhibitor may be selected from cerium compounds, lanthanum compounds, molybdate salt compounds, gluconic acid derivative salts, porous base materials, triazole compounds, thiazole compounds, tetracyclines, and metal phosphate salt compounds of ascorbic acid. The base resin may include a xylene-formaldehyde-resin-modified amino-containing epoxy resins obtained by reacting an epoxy resin having an epoxy equivalent of from 180 to 2500 with a xylene formaldehyde resin and an amino-containing compound. The curing agent may be a blocked polyisocyanate compound obtained by blocking an isocyanate group of a polyisocyanate compound with a blocking agent.

### TECHNICAL FIELD OF THE INVENTION

The present invention relates to a coating composition excellent in wet corrosion resistance such as salt spray resistance and hot-salt-water immersion resistance and dry corrosion resistance such as exposure corrosion resistance and filiform corrosion resistance, when applied to a steel sheet, aluminum material or a material made of both a steel sheet and an aluminum material, even without containing a harmful metal such as lead or chromium in its coating composition.

### DESCRIPTION OF RELATED ART

Coating compositions conventionally applied to steel sheets, aluminum materials, or materials made of both a steel sheet and an aluminum material are excellent in corrosion resistance and smoothness of a coated surface and therefore widely used for corrosion resistant coating of automotive bodies or parts.

From the environmental protection, conventional corrosion inhibitors tend to be replaced with those free of harmful metals such as lead or chromium. It is however difficult to impart a coating composition containing such a harmful-metal-free corrosion inhibitor with well balanced in salt spray resistance, hot-salt-water immersion resistance, exposure corrosion resistance and filiform corrosion resistance.

Examples of the related art include: a lead-free cationic electrodeposition coating composition containing, as a corrosion resistance improver, two different cerium hydroxycarboxylates so that a cerium concentration in the coating composition be 0.005 to 0.5 wt. % in terms of a metal (see Japanese Patent Laid-Open No. 2002-249723), an electrodeposition coating composition containing at least one lanthanum compound (see Japanese Patent Laid-Open No. Hei 5-239386), a coating composition containing a tetracycline (see Japanese Patent Laid-Open No. 2002-285092), a coating composition containing a metal phosphate salt of ascorbic acid (see Japanese Patent Laid-Open No. 2002-294161), a cationic electrodeposition coating containing at least one compound selected from silicates, borates, chromates, molybdates and tungstates of a metal selected from alkaline earth metals and zinc, and tungstic acid, which composition is to be applied to an object made of a steel material and an aluminum material in combination (see Japanese Patent Laid-Open No. Hei 6-340831), a coating composition containing a gluconic acid derivative salt (see Japanese Patent Laid-Open No. 2001-262069), a compound containing a glucose derivative compound (see Japanese Patent Laid-Open No. 2001-354906), a corrosion inhibitor obtained by impregnating or enclosing, in a porous base material, a gluconic acid compound, gluconatealt compound, triazole compound, pyrazole compound, thiadiazole compound, polyphosphoric acid compound, polyphosphate salt compound, or the like (see Japanese Patent Laid-Open No. 2002-212765), an electrodeposition coating composition obtained by reacting aluminum phosphomolybdate or a complex of aluminum phosphomolybdate and zinc oxide with a modified epoxy resin for cationization (see Japanese Patent Laid-Open No. Hei 9-124979), and a cationic electrodeposition coating composition obtained by adding a benzotriazole compound in order to prevent corrosion of iron piping of an electrodeposition bath (see Japanese Patent Laid-Open No. Hei 9-53033)

Some of the above-described inventions are effective against wet corrosion such as salt spray and hot-salt-water immersion, but not against dry corrosion such as exposure corrosion and filiform corrosion, or some of them are effective against exposure corrosion and filiform corrosion, but not against salt spray and hot-salt-water immersion.

### SUMMARY OF THE INVENTION

With regards to an object to be coated, some are effective for improving corrosion resistance of steel sheets such as cold rolled sheet or galvanized sheet but are not for aluminum materials, or some are effective for aluminum materials but not for steel sheets.

Automotive bodies or parts are usually made of both a sheet plate (cold rolled sheet, galvanized sheet) and aluminum so that there is a demand for the development of a coating composition which is not influenced by the material of an object to be coated and excellent in resistance against both wet corrosion and dry corrosion.

The present inventors have carried out an extensive investigation with a view to overcoming the above-described problems. As a result, it has been found that an object of the present invention can be attained by using a specific corrosion inhibitor and a specific base resin and a curing agent, leading to the completion of the present invention.

The present invention relates to a coating composition used for coating of a steel material and/or aluminum material, which comprises at least one corrosion inhibitor selected from the below-described corrosion inhibitors, a base resin and a curing agent.

The corrosion inhibitors to be selected may include cerium compounds, lanthanum compounds, molybdate salt compounds, gluconic acid derivative salts, porous base materials, triazole compounds, thiazole compounds, tetracyclines, and metal phosphate salt compounds of ascorbic acid.

The base resin may include a base resin (I), a xylene-formaldehyde-resin-modified amino-containing epoxy resins obtained by reacting an epoxy resin (1) having an epoxy equivalent of from 180 to 2500 with a xylene formaldehyde resin (2) and an amino-containing compound (3).

The curing agent may be a blocked polyisocyanate compound obtained by blocking an isocyanate group of a polyisocyanate compound with a blocking agent.

The base resin may be a base resin (II), a polyol-modified amino-containing epoxy resin obtained by reacting an epoxy resin (1) having an epoxy equivalent of from 180 to 2500 with a polyol compound (4) available by adding a caprolactone to a compound containing a plurality of active hydrogen group, and an amino-containing compound (3).

The base resin may also be a base resin (III), a polyol-modified amino-containing epoxy resin obtained by reacting an epoxy resin (1) having an epoxy equivalent of from 180 to 2500 with an alkyl phenol (v₁) and/or a carboxylic acid (v₂), a polyol compound (4) available by adding a caprolactone to a compound having a plurality of active hydrogen groups, and an amino-containing compound (3).

The curing agent may be a block polyisocyanate curing agent (II) obtained by reacting an active hydrogen containing component containing propylene glycol with an aromatic polyisocyanate.

The coating composition of the present invention may be a cationic electrodeposition coating.

### DETAILED DESCRIPTION OF THE INVENTION

The present invention relates to a coating composition which comprises a specific corrosion inhibitor (I) and more preferred base resin and curing agent, and has excellent corrosion resistance even when applied to an object made of a steel sheet and/or aluminum; and an article coated with the coating composition.

Corrosion Inhibitor (I)

Examples include cerium compounds such as cerium phosphate, cerium oxide and cerium gluconate; lanthanum compounds such as lanthanum oxide and lanthanum phosphate, molybdate salt compounds such as magnesium molybdate, calcium molybdate, sodium molybdate, phosphomolylbdic acid, and aluminum phosphomolybdate; tetracyclines; metal phosphate compounds of ascorbic acid such as calcium L-ascorbyl phosphate and magnesium L-ascorbyl phosphate (Phospitan C);

gluconic acid derivative salts such as iron gluconate, aluminum gluconate, sodium gluconate and cerium gluconate;

porous base materials such as calcite type porous CaCO₃ (“CALIGHT KT”, trade name);

triazole compounds such as 3-amino-1,2,4-triazole and 3-mercapto-1,2,4-triazole; thiazole compounds such as 2-mercaptobenzothiazole, 2-benzothiazolylthiopropionic acid (4-methyl PBT), 2-benzothiazolylthioacetic acid (“SANBIT ABT”, trade name) and 2-mercaptobenzothiazole (“SANCELER M-G”, “SANCELENT M-O”, each trade name);

the other compounds such as 9,10-dihydro-9-oxa-10-phosphaphenanthren-10-oxide (HCA), (9,10-dihydro-9-oxa-10-phosphaphenanthren-10-oxide) zinc salt (HCA-Zn), 3,5-di(α-methylbenzyl)salicylic acid, zinc 3,5-di((α-methylbenzyl)salicylate, sodium metavanadate, sodium dihydrogen phosphate, ammonium metavanadate, calcium borate, sodium tripolyphosphate, sodium magnesium hexametaphosphate (NMC-4), sodium hexametaphosphate, disodium sebacate and sodium tripolyphosphate; and “IXE-100” (Zr type) and “IXE-600” (Bi—Sb type) (each, trade name of IXE series corrosion inhibitor produced by Toagosei Co., Ltd.).

Classification of Corrosion Inhibitors (I) by Function

By classifying the corrosion inhibitors into group (i), group (ii), and group (iii), and adding a combination of at least one of the inhibitors in group (i) and that in group (ii), at least one of the inhibitors in group (i) and that in group (iii) or at least one of the inhibitors in group (ii) and that in group (iii) to the coating composition, the coating composition acquires more improved corrosion resistance owing to both corrosion inhibiting effects, that is, “effects for inhibiting the generation of corrosion” and “effects for inhibiting the progress of corrosion”, compared with the use of a single corrosion inhibitor selected from them.

Corrosion inhibitors in the group (i) inhibit progress and generation of corrosion by trapping (holding) material ions (for example, Fe²⁺, Zn²⁺, and Al³⁺), which have been eluted by corrosion, or corrosion promoting substances (oxygen, water and Cl⁻) passing through a coating film, or by forming a stable substance (corrosion suppressing substance) with them by a chelating action.

More specifically, in the case of trapping (holding) of material ions eluted by corrosion or formation of a stabilizing substance by chelating, “the progress of corrosion” is inhibited by suppressing a phenomenon appearing after the occurrence of initial corrosion. In the case of trapping (holding) of corrosion promoting substances passing through the coating film or retardation of corrosion by chelating action, “the generation of corrosion” is inhibited by suppressing a phenomenon appearing prior to the occurrence of initial corrosion. The corrosion inhibitors in the group (i) are therefore effective for both “the progress and generation of corrosion”.

For steel materials, for example, calcite type porous CaCo₃ (“CALIGHT KT”), “IXE-100” and “IXE-600” (each, trade name of IXE series corrosion inhibitor, product of Toagosei Co., Ltd.), 9,10-dihydro-9-oxa-10-phosphaphenanthren-10-oxide, (9,10-dihydro-9-oxa-10-phosphaphenanthren-10-oxide) zinc salt, 3,5-di(α-methylbenzyl)salicylic acid, zinc 3,5-di((α-methylbenzyl)salicylate, and ammonium metavanadate are preferred.

For aluminum materials, for example, calcite type porous CaCo₃ (“CALIGHT KT”), and “IXE-100” (Zr series corrosion inhibitor) and “IXE-600” (Bi—Sb series corrosion inhibitor) (each, trade name of IXE series corrosion inhibitor, product of Toagosei Co., Ltd.) are preferred.

Corrosion inhibitors in the group (ii) inhibit generation of corrosion by precipitating on the interface between a coated material and a coating film upon electrodeposition coating to form a stable protective film against corrosion. More specifically, it is a corrosion inhibitor having an inhibitory effect against “generation of corrosion” by inhibiting a phenomenon occurring prior to generation of initial corrosion.

For steel materials, for example, sodium molybdate, sodium dihydrogen phosphate, sodium metavanadate, magnesium molybdate, 3-amino-1,2,4-triazole, 3-mercapto-1,2,4-triazole, 2-benzothiazolylthiopropionic acid, 2-benzothiazolylthioacetic acid, 9,10-dihydro-9-oxa-10-phosphaphenanthren-10-oxide, 3,5-di(α-methylbenzyl)salicylic acid and 2-mercaptobenzothiazole are preferred.

For aluminum materials, for example, sodium molybdate, phosphomolybdic acid, sodium dihydrogen phosphate and sodium metavanadate are preferred.

Corrosion inhibitors in the group (iii) suppresse corrosion in the following manner: when initial corrosion occurs, a pH increasing site (cathode portion) or pH lowering site (anode portion) appears on the interface between the coated material and coating film. This causes elution of the corrosion inhibitor from the coating film. The corrosion inhibitor thus eluted reacts with ions (for example, Fe²⁺, Zn²⁺, Al³⁺) eluted from the coated material by corrosion or corrosion promoting substances (oxygen, water, Cl⁻) and forms a stable protecting film. More specifically, they are effective for the inhibition of “progress of corrosion” by suppressing a phenomenon occurring after the generation of initial corrosion.

For steel materials, for example, iron gluconate, sodium gluconate, aluminum gluconate, calcium L-ascorbyl phosphate, magnesium L-ascorbyl phosphate, ammonium metavanadate, phosphomolybdic acid, sodium tripolyphosphate, lanthanum oxide, lanthanum phosphate, cerium oxide, cerium phosphate, calcium borate, 9,10-dihydro-9-oxa-10-phosphaphenanthren-10-oxide, (9,10-dihydro-9-oxa-10-phosphaphenanthren-10-oxide) zinc salt, 3,5-di(α-methylbenzyl)salicylic acid, zinc 3,5-di(α-methylbenzyl)salicylate, sodium hexametaphosphate, magnesium hexametaphosphate and sodium hexametaphosphate are preferred.

For aluminum materials, lanthanum phosphate, cerium phosphate, 9,10-dihydro-9-oxa-10-phosphaphenanthren-10-oxide, (9,10-dihydro-9-oxa-10-phosphaphenanthren-10-oxide zinc salt, 3,5-di(α-methylbenzyl)salicylic acid, zinc 3,5-di(α-methylbenzyl)salicylate, tetracycline, disodium sabacate, calcium L-ascorbyl phosphate, magnesium L-ascorbyl phosphate (Phospitan C), sodium.magnesium hexametaphosphate (NMC-4), sodium hexametaphosphate and magnesium molybdate are preferred.

Base Resins and Curing Agents

Base resins and curing agents exhibiting improved corrosion resistance when used in combination with the above-described corrosion inhibitor (I) found by the present inventors will next be described.

Amine-added epoxy resins and block polyisocyanates having a cyclic structure have been used popularly as the base resin and curing agent for conventional cationic coating compositions, respectively, because they are excellent from the viewpoint of corrosion resistance.

The epoxy resin used as the base resin has, similar to the conventional base resins, preferably an average molecular weight of from 1,000 to 10,000, more preferably from 2,000 to 5,000. Average molecular weights exceeding 10,000 increase a resin viscosity and thereby deteriorate thermal fluidity upon baking, which leads to poor finish property of an electrodepositing coating film. Average molecular weights less than 1,000, on the other hand, make it difficult to adjust an amine number by the amount of amine, leading to undesirable lowering in the dispersibility of the emulsion.

The amine compound to be added to an epoxy resin preferably contains a primary amino group and has an amine number ranging from 30 to 70 mgKOH/g resin content, preferably from 40 to 60 mgKOH/g resin content or less. The modification amount must be suppressed to the minimum amount necessary for plasticization and from 5 to 50 parts by weight, more preferably from 10 to 30 parts by weight is preferred based on 100 parts by weight of the epoxy resin.

The base resin is preferably polarized inside by using a hydrophobic modifier. Examples include xylene-formaldehyde-resin-modified amino-containing epoxy resins, polyol-modified amino-containing epoxy resins, and polyol-modified amino-containing epoxy resins added with an alkyl phenol and/or carboxylic acid, each obtained by reacting with an epoxy group by using a modifier as described above. Base resin (I)

The xylene-formaldehyde-resin-modified amino-containing epoxy resin is an amino-containing epoxy resin (which may hereinafter be called “base resin (I)”) obtained by reacting an epoxy resin (1) having an epoxy equivalent of from 180 to 2500 with a xylene formaldehyde resin (2) and an amino-containing compound (3).

As the epoxy resin (1) used as a starting material of the base resin, those available by the reaction between a polyphenol compound and an epihalohydrin, for example, epichlorohydrin are particularly suited from the viewpoint of the corrosion resistance of a coating film.

As the polyphenol compound to be used for the formation of the epoxy resin, those ordinarily employed can be used. Examples include bis(4-hydroxypheny)-2,2-propane (bisphenol A), 4,4-dihydroxybenzophenone, bis(4-hydroxyphenyl)methane (bisphenol F), bis(4-hydroxyphenyl)-1,1-ethane, bis(4-hydroxyphenyl)-1,1-isobutane, bis(4-hydroxy-tert-butyl-phenyl)-2,2-propane, bis(2-hydroxynaphthyl)methane, tetra(4-hydroxyphenyl)-1,1,2,2,-ethane, 4,4-dihydroxydiphenylsulfone (bisphenol S), phenol novolac and cresol novolac.

Among the epoxy resins available by the reaction between a polyphenol compound and epichlorohydrin, those derived from bisphenol A and represented by the following formula: 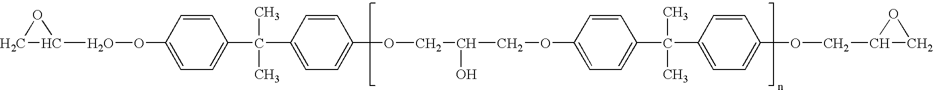
wherein n stands for 0 to 8 are preferred.

The epoxy resin. (1) may have an epoxy equivalent usually from 180 to 2,500, preferably from 200 to 2,000, more preferably from 400 to 1,500. Those having a number-average molecular weight of usually at least 200, especially within a range of from 400 to 4,000, more especially from 800 to 2,500 are suited.

Examples of the commercially available epoxy resins satisfying the above-described properties include those marketed under the name of “EPIKOTE 828EL, 1002, 1004 and 1007”, from Japan Epoxy Resins Co., Ltd.

The xylene formaldehyde resin (2) is useful for the internal plasticization (modification) of the epoxy resin (1). It can be prepared, for example, by condensation reaction of xylene and formaldehyde and optionally a phenol in the presence of an acid catalyst.

As the formaldehyde, those generating formaldehyde such as industrially easily available formalin, paraformaldehyde and trioxane can be used. When a polymer such as paraformaldehyde or trioxane is used herein, the amount of it should be specified based on one molecule of formaldehyde.

The above-described phenols embrace monovalent or divalent phenol compounds having two or three reaction sites. Specific examples include phenol, cresols, para-octylphenol, nonylphenol, bisphenol propane, bisphenol methane, resorcin, pyrocatechol, hydroquinone, para-tert-butylphenol, bisphenol sulfone, bisphenol ether and paraphenylphenol. They may be used either singly or in combination. Of these, phenol and cresols are particularly preferred.

Examples of the acid catalyst to be used for the condensation reaction of the above-described xylene and formaldehyde and optionally phenol include sulfuric acid, hydrochloric acid, paratoluenesulfonic acid and oxalic acid. Usually, sulfuric acid is particularly suited. The amount of the catalyst may fall within a range of from 10 to 50 wt. % as a concentration in an aqueous solution, because it is diluted with water in the aqueous formaldehyde solution.

The condensation reaction may be effected usually by heating to about 80 to about 100° C. at which reflux of xylene, phenol, water and formalin existing in the reaction system occurs and the reaction can be completed usually in about 2 to 6 hours.

The xylene formaldehyde resin is available by reacting xylene and formaldehyde and optionally phenol by heating in the presence of the acid catalyst under the above-described conditions.

The xylene formaldehyde resin thus obtained may have a viscosity usually within a range of from 20 to 50,000 centipoise (25° C.), preferably within a range of from 30 to 15,000 centipoise (25° C.). It preferably has a hydroxyl equivalent usually ranging from 100 to 50,000, especially from 200 to 10,000.

The amino-containing compound (3) is a component for introducing an amino group into the epoxy resin (1) to cationize it and that containing at least one active hydrogen which is to react with the epoxy resin is employed.

Examples of the amino-containing compound (3) used for such a purpose include mono- or di-alkylamines such as monomethylamine, dimethylamine, monoethylamine, diethylamine, monoisopropylamine, diisopropylamine, triisopropylamine, monobutylamine and dibutylamine; alkanolamines such as monoethanolamine, diethanolamine, mono(2-hydroxypropyl)amine, di(2-hydroxypropyl)amine, tri(2-hydroxypropyl)amine, monomethylaminoethanol, and monoethylaminoethanol; alkylene polyamines such as ethylenediamine, propylenediamine, butylenediamine, hexamethylenediamine, tetraethylenepentamine, pentaethylenehexamine, diethylaminopropylamine, diethylenetriamine and triethylenetetramine and these polyamines having ketimine introduced therein; alkyleneimines such as ethyleneimine and propyleneimine; and cyclic amines such as piperazine, morpholine and pyrazine.

The base resin (I) to be used as a vehicle in the coating composition of the present invention can be prepared by reacting the epoxy resin (1) with the xylene formaldehyde resin (2) and the amino-containing compound (3) in a manner per se in the art.

Although the reaction of the epoxy resin (1) with the xylene formaldehyde resin (2) and amino-containing compound (3) may be effected in a desired order, it is usually preferred to react the epoxy resin (1) with the xylene formaldehyde resin (2) and amino-containing compound (3) simultaneously.

The above-described addition reaction may be performed usually in a proper solvent at from about 80 to about 170° C., preferably from about 90 to about 150° C. for about 1 to 6 hours, preferably for 1 to 5 hours. Examples of the solvent include hydrocarbons such as toluene, xylene, cyclohexane and n-hexane; esters such as methyl acetate, ethyl acetate and butyl acetate, ketones such as acetone, methyl ethyl ketone, methyl isobutyl ketone and methyl amyl ketone, amides such as dimethylformamide and dimethylacetamide, and alcohols such as methanol, ethanol, n-propanol and iso-propanol, and mixtures thereof.

The proportion of the reaction components in the above-described addition reaction is not strictly limited and can be changed as needed, depending on the using purpose of the coating composition. The appropriate proportion is within the below-described range based on the total solid content of the three components, that is, epoxy resin (1), xylene formaldehyde resin (2) and amino-containing compound (3).

Epoxy resin (1): usually from 50 to 90 wt. %, preferably from 50 to 85 wt. %, xylene formaldehyde resin (2): usually from 5 to 45 wt. %, preferably from 6 to 43 wt. %, and amino-containing compound (3): usually from 5 to 25 wt. %, preferably from 6 to 20 wt. %. The using ratios outside the above-described range may deteriorate any of corrosion resistance, finish property and stability so they are not preferred.

A resin component obtained by reacting, with the epoxy resin (1), xylene formaldehyde resin (2) and amino-containing compound (3), a polyol compound (4) available by adding a caprolactone to a compound containing a plurality of active hydrogen groups can also be employed.

The polyol compound (4) is added for the purpose of internal plasticization (modification) of the above-described epoxy resin (1) and it is prepared by adding a caprolactone to a compound containing a plurality of active hydrogen groups.

The term “active hydrogen group” means an atomic group having at least one active hydrogen and it embraces, for example, alcoholic hydroxyl group, primary amino groups and secondary amino groups. Examples of the compound containing, in one molecule thereof, a plurality of active hydrogen groups include low-molecular-weight polyols, linear or branched polyether polyols, linear or branched polyester polyols, amino compounds having a primary amino group and/or a secondary amino group, and hydroxylamine compounds having a primary amino group and/or a secondary amino group in combination with a hydroxyl group. The active-hydrogen-containing compound (a) may have a number-average molecular weight usually ranging from 62 to 5,000, preferably from 62 to 4,000, more preferably from 62 to 1,500. The active-hydrogen-containing compound (a) preferably has, in one molecule thereof, 2 or greater but less than 30, especially from 2 to 10 active hydrogen groups on average.

The above-described low-molecular-weight polyols (i) are each a compound having, in one molecule thereof, at least two alcoholic hydroxyl groups and specific examples include diols such as ethylene glycol, propylene glycol, 1,3-butylene glycol, 1,4-butanediol, 1,6-hexanediol, diethylene glycol, dipropylene glycol, cyclohexane-1,4-dimethylol, neopentyl glycol, triethylene glycol and hydrogenated bisphenol A; triols such as glycerin, trimethylolethane and trimethylolpropane; tetrols such as pentaerythritol and α-methylglucoxide; hexols such as sorbitol and dipentaerythritol; and octols such as sucrose.

The above-described linear or branched polyether polyols may each have a number average molecular weight usually ranging from 62 to 10,000, preferably from 62 to 2,000. Specific examples include polyethylene glycol, polypropylene glycol, polytetramethylene glycol, poly(ethylene.propylene)glycol, bisphenol A ethylene glycol ether and bisphenol A polypropylene glycol ether, each available by ring-opening addition reaction of an alkylene oxide (for example, ethylene oxide, propylene oxide, butylenes oxide, tetrahydrofuran, etc.).

The above-described linear or branched polyester polyols may each have a number average molecular weight of usually from 200 to 10,000, preferably from 200 to 3,000. Specific examples include those available by polycondensation reaction of an organic dicarboxylic acid or anhydride thereof with an organic diol under excessive amount of the organic diol.

Examples of the organic dicarboxylic acid to be used in the above reaction include aliphatic, alicyclic or aromatic dicarboxylic acids having from 2 to 44 carbon atoms, especially from 4 to 36 carbon atoms, for example, succinic acid, adipic acid, azelaic acid, sebacic acid, maleic acid, fumaric acid, glutaric acid, hexachloroheptanedicarboxylic acid, cyclohexanedicarboxylic acid, o-phthalic acid, isophthalic acid, terephthalic acid, tetrahydrophthalic acid, and tetrachlorophthalic acid. In addition to these dicarboxylic acids, a small amount of anhydride of a polycarboxylic acid having at least 3 carboxyl groups, adducts of an unsaturated fatty acid and the like can be used in combination.

Examples of the organic diol component include alkylene glycols such as ethylene glycol, propylene glycol, butylene glycol, 1,4-butanediol, 1,6-hexanediol and neopentyl glycol, and dimethylolcyclohexane. They may be used in combination with a small amount of a polyol such as trimethylolpropane, glycerin or pentaerythritol, if necessary.

Examples of the above-mentioned amine compound containing a primary amino group and/or a secondary amino group or amine compounds containing a primary amino group and/or a secondary amino group in combination with a hydroxyl group include alkylamines such as butylenediamine, hexamethylenediamine, tetraethylenepentamine, and pentaethylenehexamine; alkanolamines such as monoethanolamine, diethanolamine, triethanolamine, mono(2-hydroxypropyl)amine, and di(2-hydroxypropyl)amine; alicyclic polyamines such as 1,3-bisaminomethylcyclohexanone, and isophoronediamine; aromatic polyamines such as xylylenediamine, meta-xylenediamine, diaminodiphenylmethane, and phenylenediamine; alkylenepolyamines such as ethylenediamine, propylenediamine, diethylenetriamine, and triethylenetetramine; and amine adducts with a polyamide, polyamidoamine or epoxy compound which are derived from piperazine or the above-described polyamines, and the other amine compounds such as ketimine and aldimine.

Of the above-described compounds containing a plurality of active hydrogen groups, those selected from the group consisting of ethylene glycol, propylene glycol, butylenes glycol, 1,4-butanediol, 1,6-hexanediol, diethylene glycol, hydrogenated bisphenol A, glycerin, trimethylolethane, trimethylolpropane, pentaerythritol, dipentaerythritol, polyethylene glycol, polypropylene glycol, polytetramethylene glycol, poly(ethylene.propylene)glycol, bisphenol A ethylene glycol ether, bisphenol A polypropylene glycol ether, butylenediamine, hexamethylenediamine, monoethanolamine, diethanolamine, triethanolamine, isophoronediamine, ethylenediamine, propylenediamine, diethylenetriamine and triethylenetetramine are preferred.

On the other hand, as the caprolactone which can be added to the compound containing a plurality of active hydrogen groups, γ-caprolactone, ε-caprolactone, and δ-caprolactone can be given as examples, with ε-caprolactone being especially preferred.

The addition reaction of the compound containing a plurality of active hydrogen groups and the caprolactone can be performed in a manner known per se in the art. More specifically, it can be conducted by heating the compound containing a plurality of active hydrogen groups and the caprolactone at about 100 to about 250° C. for about 1 to about 15 hours in the presence of a catalyst, for example, a titanium compound such as tetrabutoxytitanium or tetrapropoxytitanium, an organic tin compound such as tin octylate, dibutyltin oxide or dibutyltin laurate; or a metal compound such as stannous chloride.

The amount of the catalyst may usually be from 0.5 to 1,000 ppm based on the total amount of the compound containing a plurality of active hydrogen groups and caprolactone. The caprolactone may be used within a range of usually from 1 to 30 moles, preferably from 1 to 20 moles, more preferably from 1 to 15 moles per equivalent of an active hydrogen group (that it, per active hydrogen) of the compound containing a plurality of active hydrogen groups.

The polyol compound (4) thus obtained has a high plasticizing performance attributable to the compound containing a plurality of active hydrogen groups, high compatibility with the epoxy resin attributable to the (poly)caprolactone and high reactivity attributable to the terminal hydrogen group so that it is very useful as an internal plasticizer of an epoxy resin for paint.

The polyol compound (4) may contain units derived from the caprolactone in a total amount of usually from 20 to 95 wt. %, preferably from 25 to 90 wt. % and it may have a number-average molecular weight usually ranging from 300 to 10,000, preferably from 400 to 5,000.

The resin having the polyol compound (4) as an additional reaction component can be prepared in a similar manner to that described above. It is usually preferred to react the epoxy resin (1) with the xylene formaldehyde resin (2), amino-containing compound (3) and polyol compound (4) simultaneously.

No strict limitation is imposed on the proportion of the reaction components in the above-described reaction and it can be changed as needed, depending on the using purpose of the cationic coating composition. The proportions of the epoxy resin (1), xylene formaldehyde resin (2), amino-containing compound (3) and polyol compound (4) preferably fall within the below-described ranges based on the total solid content of these four components.

epoxy resin (1): usually, from 50 to 85 wt. %, preferably from 50 to 80 wt. %,

xylene formaldehyde resin (2): usually, from 5 to 45 wt. %, preferably from 6 to 40 wt. %,

amino-containing compound (3): usually from 5 to 25 wt. %, preferably from 6 to 20 wt. %,

polyol compound (4): usually from 1 to 20 wt. %, preferably from 2 to 15 wt. %. The proportions outside the above-described ranges are not preferred, because they lead to a deterioration in any of corrosion resistance, finish property and stability.

The addition reaction of the amino-containing compound (3) and xylene formaldehyde resin (2), and/or polyol compound (4) to the epoxy resin (1) may be performed usually in a proper solvent at about from 80 to about 170° C., preferably from about 90 to about 150° C. for about 1 to 6 hours, preferably from 1 to 5 hours.

Examples of the solvent used in the above reaction include hydrocarbons such as toluene, xylene, cyclohexane and n-hexane; esters such as methyl acetate, ethyl acetate and butyl acetate, ketones such as acetone, methyl ethyl ketone, methyl isobutyl ketone and methyl amyl ketone, amides such as dimethylformamide and dimethylacetamide, and alcohols such as methanol, ethanol, n-propanol and iso-propanol, and mixtures thereof.

No strict limitation is imposed on the proportion of the above-described modifier and it can be changed as needed, depending on the using purpose of the coating composition or the like. The appropriate proportion ranges from 5 to 50 wt. %, preferably from 10 to 30 wt. % based on the solid content of the epoxy resin. When the proportion is less than the above-described range, an amount of a neutralizer for the resin must be increased. Proportions exceeding the above-described range lower the water dispersion stability and are therefore unsuited.

Base Resin (II): As the base resin in the coating composition, it is possible to use, instead of the xylene-formaldehyde-resin-modified amino-containing epoxy resin, a polyol-modified amino-containing epoxy resin (which may hereinafter be abbreviated as “base resin (II)”) obtained by reacting an epoxy resin (1) having an epoxy equivalent of from 180 to 2500 with an amino-containing compound (3) and a polyol compound (4) available by adding a caprolactone to a compound containing a plurality of active hydrogen groups. As the epoxy resin (1), an epoxy resin similar to that employed in the preparation of the base resin (I) can be used.

The polyol compound (4) is used for internal plasticization (modification) of the epoxy resin (1) and can be prepared by adding a caprolactone to a compound containing a plurality of active hydrogen groups. A polyol compound similar to that used in the preparation of the base resin (1) can be employed.

The polyol compound (4) may be added in an amount usually ranging from 20 to 95 wt. %, preferably from 25 to 90 wt. % as a unit derived from a caprolactone. It may have a number average molecular weight of usually from 300 to 10,000, preferably from 400 to 5,000.

The amino-containing compound (3): The amino-containing compound (3) to be reacted with the epoxy resin (1) in the present invention is a cationizing component of the epoxy resin by introducing an amino group into the epoxy resin base. As the amino-containing compound, that having at least one active hydrogen which will react with an epoxy group is employed. An amino-containing compound similar to that employed in the preparation of the base resin (I) can be used.

In the coating composition, the base resin (II) is available by the addition reaction of the amino-containing compound (3) and the polyol compound (4) having a caprolactone-derived terminal hydroxyl group to the epoxy resin (1) in a manner known per se in the art.

The reaction of the epoxy resin (1) with the amino-containing compound (3) and polyol compound (4) and may be effected in a desired order, but usually it is preferred to react the epoxy resin (1) with the amino-containing compound (3) and polyol compound (4) simultaneously. The base resin thus obtained preferably has a terminal of the polyol compound (4) added to the backbone of the epoxy resin (1).

The above-described addition reaction may be carried out usually in a proper solvent at about 90 to about 170° C., preferably at about 100 to about 150° C. for about 1 to 5 hours, preferably for 2 to 4 hours. Examples of the solvent include hydrocarbons such as toluene, xylene, cyclohexane and n-hexane; esters such as methyl acetate, ethyl acetate and butyl acetate, ketones such as acetone, methyl ethyl ketone, methyl isobutyl ketone and methyl amyl ketone, amides such as dimethylformamide and dimethylacetamide, and alcohols such as methanol, ethanol, n-propanol and iso-propanol, and mixtures thereof.

The proportion of the reaction components in the above-described addition reaction is not strictly limited and can be changed as needed, depending on the using purpose of the coating composition or the like. The appropriate proportions of the epoxy resin (1), amino-containing compound (3) and polyol compound (4) are within the below-described ranges based on the total solid content of these three components.

Epoxy resin (1): usually, from 60 to 90 wt. %, preferably from 62 to 85 wt. %, more preferably from 62 to 80 wt. %,

amino-containing compound (3): usually from 5 to 25 wt. %, preferably from 6 to 19 wt. %, more preferably from 6 to 18 wt. %,

polyol compound (4); usually from 5 to 30 wt. %, preferably from 5 to 20 wt. %, more preferably from 5 to 18 wt. %.

The proportions outside the above-described ranges are not preferred, because they lead to a deterioration in any of corrosion resistance, finish property and stability.

Base Resin (III): As the base resin in the cationic coating composition, it is possible to use, instead of the base resin (I) or base resin (II), a polyol-modified amino-containing epoxy resin added with an alkyl phenol and/or a carboxylic acid (which resin may hereinafter be abbreviated as “base resin (III)”) obtained by reacting an epoxy resin (1) with an alkyl phenol (v₁) and/or a carboxylic acid (v₂), an amino-containing compound (3), and a polyol compound (4) available by adding a caprolactone to a compound containing a plurality of active hydrogen groups.

As the epoxy resin (1), an epoxy resin similar to that employed in the preparation of the base resin (I) or base resin (II) can be used.

An alkyl phenol in an alkylphenol and/or a carboxylic acid is represented by the following chemical formula (1): 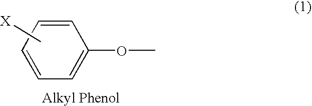
(wherein, X represents a hydrogen atom or a C₁₋₁₅ hydrocarbon group which may have a substituent selected from the group consisting of —OH, —OR, —SH and —SR, in which R represents an alkyl group).

In the above-described formula (1), the C₁₋₁₅ hydrocarbon group represented by X may be any one of linear, branched and cyclic groups and of these, C₁₋₁₅, especially C₁₋₁₂ alkyl groups, for example, methyl, ethyl, n-propyl, isopropyl, n-butyl, tert-butyl and nonyl groups are preferred. These groups may be substituted with a substituent selected from the group consisting of a hydroxyl group (—OH), alkoxy groups (—OR), a mercapto group (—SH) and alkylthio groups (—SR).

Specific examples of the alkyl phenols represented by the formula (1) include phenol, cresol, ethylphenol, para-tert-butylphenol and nonylphenol.

The carboxylic acid is at least one compound selected from the group consisting of carboxylic acids represented by the following chemical formula (2): 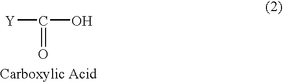
(wherein, Y represents a C₁₋₁₅ hydrocarbon group which may have a substituent selected from the group consisting of —OH, —OR, —SH and —SR, in which R represents an alkyl group).

In the above-described chemical formula (2), the C₁₋₁₅ hydrocarbon group represented by Y may be linear, branched or cyclic. Specific examples include alkyl groups such as methyl, ethyl, n-propyl, isopropyl, n-butyl and nonyl, alkenyl groups such as vinyl and oleyl and aryl groups such as phenyl. These groups may be substituted by at least one, preferably 1 to 3 substituents selected from the group consisting of hydroxyl group, alkoxy groups, mercapto group and alkylthio groups. Examples of the hydrocarbon group substituted with such a substituent include 1-hydroxyethyl, 1,1-dimethylolethyl, 1,1-dimethylolpropyl and 3,4,5-trihydroxyphenyl groups.

Specific examples of the compound represented by the chemical formula (2) include acetic acid, propionic acid, butyric acid, valeric acid, acrylic acid, oleic acid, glycolic acid, glyceric acid, lactic acid, dimethylolpropionic acid, dimethylolbutyric acid, dimethylolvaleric acid, benzoic acid and gallic acid. Of these, acetic acid, propionic acid, butyric acid, oleic acid, dimethylolpropionic acid, dimethylolbutyric acid, dimethylolvaleric acid and benzoic acid are preferred.

The polyol compound (4) is a polyol obtained by adding a caprolactone to a compound having a plurality of active hydrogen groups. A polyol compound similar to that used for the base resin (I) or base resin (II) can be employed.

Such a polyol compound (4) has, at one end thereof, a polycaprolactone-derived hydroxyl group and has a high plasticizing performance attributable to the polyol, a high compatibility with the epoxy resin attributable to the polycaprolactone, and a high reactivity attributable to the end hydroxyl group so that it has improved adhesion and permeation inhibiting performance. The addition of it therefore contributes to an improvement in corrosion resistance.

As the amino-containing compound (3), an amino-containing compound similar to that used for the base resin (I) or base resin (II) can be employed. Specific examples include alkylamines such as monomethylamine, dimethylamine, monoethylamine, diethylamine, monoisopropylamine, diisopropylamine, monobutylamine, dibutylamine, butylenediamine, hexamethylenediamine, tetraethylenepentamine, pentaethylenehexamine, and diethylaminopropylamine; and monoethanolamine, diethanolamine, mono(2-hydroxypropyl)amine, and di(2-hydroxypropyl)amine and these polyamine compounds having ketimine introduced therein.

The base resin (III) contains the above-described components, based on the total solid content of them, in the below-described ranges, respectively: epoxy resin (1) within a range of from 60 to 85 wt. %, the alkyl phenol and/or carboxylic acid within a range of from 2 to 15 wt. %, the amino-containing compound (3) within a range of from 5 to 25 wt. % and the polyol compound (4), which is available by adding a caprolactone to a compound having a plurality of active hydrogen groups, within a range of from 5 to 20 wt. %. Proportions outside the above-described ranges lead to a deterioration in any of corrosion resistance, finish property and stability.

Curing agent (I): In addition to the base resin, the cationic coating composition may contain, as a curing agent, a blocked polyisocyanate compound obtained by blocking the isocyanate group of a polyisocyanate compound with a blocking agent.

As the curing agent, either one of aromatic or alicyclic isocyanate can be used, but that having, in one molecule thereof, at least 1.5, especially 2 to 3 ring structures on average is preferred. Examples of the isocyanate compounds particularly preferred as a raw material include diphenylmethane diisocyanate and hydrogenated diphenylmethane diisocyanate.

Specific examples of such a polyisocyanate include diphenylmethane-2,4′- and/or -4,4′-diisocyanate (which is usually called “MDI”), crude MDI and hydrogenated MDI, and adducts thereof with a polyol, adducts of tolylene diisocyanate, xylylene diisocyanate or phenylene diisocyanate with a polyol, adducts of isophorone diisocyanate or bis(isocyanatomethyl)cyclohexane with a polyol, and isocyanurate compounds such as tetramethylene diisocyanate and hexamethylene diisocyanate of these, crude MDI and hydrogenated MDI are particularly preferred as the polyisocyanate compound.

As the blocking agent, preferred is a blocking agent which is to be added to the isocyanate group of a polyisocyanate compound to block it. The block polyisocyanate compound obtained by the addition reaction is stable at normal temperature. It preferably undergoes dissociation when heated to the baking temperature (usually, about 100 to 200° C.) of a coating film to release the isocyanate group as a free one.

Examples of the blocking agent include lactam compounds such as ε-caprolactam and γ-butyrolactam; oxime compounds such as methyl ethyl ketoxime and cyclohexanone oxime; phenol compounds such as phenol, para-t-butylphenol and cresol; aliphatic alcohols such as n-butanol and 2-ethylhexanol; aromatic alkyl alcohols such as phenylcarbinol and methylphenylcarbinol; and ether alcohols such as ethylene glycol monobutyl ether and diethylene glycol monoethyl ether.

Curing Agent (II):

The cationic coating composition may contain a curing agent (II) obtained by reacting an active-hydrogen-containing component and an aromatic polyisocyanate compound.

Examples include alcohol compounds containing a primary and secondary or primary and tertiary hydroxyl groups such as propylene glycol, dipropylene glycol, 1,3-butanediol, 1,2-butanediol, 3-methyl-1,2-butanediol, 1,2-pentanediol, 1,4-pentanediol, 3-methyl-4,3-pentanediol, 3-methyl-4,5-pentanediol, 2,2,4-trimethyl-1,3-pentanediol, 1,4-hexanediiol and 1,5-hexanediol.

As the blocking agent, those having a low molecular weight and a high dissociation property are preferred. Use of propylene glycol which is an alcohol compound containing primary and secondary hydroxyl groups and methyl ethyl ketoxime which is an oxime compound are especially preferred for diphenylmethane diisocyanate and hydrogenated diphenylmethane diisocyanate, respectively.

In the coating composition, the proportion of the base resin usually ranges from 55 to 90 wt. %, preferably from 65 to 80 wt. % and that of the curing agent usually ranges from 10 to 45 wt. %, preferably from 20 to 35 wt. %, each based on the total solid content weight of these two components.

The coating composition containing the base resin and curing agent can be prepared as a cationic electrodeposition coating by fully mixing the base resin and curing agent, neutralizing the resulting mixture with a water soluble organic carboxylic acid usually in an aqueous medium and then solubilizing or dispersing the epoxy resin in water.

As the organic carboxylic acid for neutralization, acetic acid and formic acid, and mixture thereof are particularly preferred. When such an acid is employed, a coating film thus formed has improved corrosion resistance and finish property, and the coating stability of the coating composition is also improved.

No particular limitation is imposed on a pigment to be used in the cationic coating composition insofar as it is a conventionally employed pigment. Examples include coloring pigments such as titanium oxide, carbon black and iron oxide red, and extender pigments such as clay, mica, baryta, calcium carbonate and silica.

In addition, a bismuth compound can be incorporated in order to improve corrosion resistance. Examples include bismuth oxide, bismuth hydroxide, basic bismuth carbonate, bismuth nitrate, bismuth silicate, and organic acid bismuth compounds, each prepared by reacting at least two organic acids with a bismuth compound as described above wherein at least one of the organic acids is an aliphatic hydroxycarboxylic acid. These pigments may be added in an amount of from 1 to 100 parts by weight, especially from 10 to 50 parts by weight based on 100 parts by weight of the total solid content of the base resin and curing agent.

The cationic coating composition may further contain a curing catalyst and a precipitation inhibitor. The curing catalyst is effective for promoting the crosslinking reaction between the base resin and the curing agent. Examples include dioctyltin oxide, dibutyltin oxide, tin octoate, dibutyltin dilaurate, dibutyltin dibenzoate, zinc octylate and zinc formate. It is preferably added in an amount of from 0.1 to 10 parts by weight, based on 100 parts by weight of the total of the base resin and curing agent.

The cationic coating composition is preferably obtained by preparing the above-described pigment-dispersed paste in advance, and mixing it with an emulsion having the base resin and curing agent dispersed therein.

Examples of an object to be coated with the cationic electrodeposition coating obtained as described above include cold-rolled sheets for automotive bodies and automotive parts, hot-dip galvanized steel sheets, electrogalvanized steel sheets, zinc-iron electroplated steel sheets, organic composite plated steel sheets, and aluminum; and mixtures thereof.

The present invention provides a coating composition containing a specific corrosion inhibitor, a base resin and a curing agent in combination. Articles coated with this coating composition are excellent in both wet corrosion resistance such as salt spray resistance and hot-salt-water immersion resistance and dry corrosion resistance such as exposure corrosion resistance and filiform corrosion resistance.

Examples of the specific corrosion inhibitor include cerium compounds, lanthanum compounds, molybdate salt compounds, gluconic acid derivative salts, glucose derivatives, porous base materials, thiazole compounds, tetracyclines, and metal phosphate compounds of ascorbic acid.

By classifying the corrosion inhibitors into group (i), group (ii), and group (iii) and adding a combination of at least one of the inhibitors in group (i) and that in group (ii), at least one of the inhibitors in group (i) and that in group (iii) or at least one of the inhibitors in group (ii) and that in group (iii) to the coating composition, the coating composition is able to have more improved corrosion resistance owing to both corrosion inhibiting effects, that is, “effects for inhibiting the generation of corrosion” and “effects for inhibiting the progress of corrosion”, compared with the single use of the corrosion inhibitor.

### EXAMPLES

Examples and Comparative Examples of the present invention will hereinafter be described. All designations of “part” or “parts” and “%” mean part or parts by weight and wt. %. It should however be borne in mind that the present invention is not limited only to these Examples.

### Preparation Example 1

### Pigment Dispersed Paste No. 1

A mixture of 5.83 parts (solid content: 3.5 parts) of epoxy quaternary-ammonium type dispersing resin having a solid content of 60%, 2.0 parts of cerium phosphate, 14.5 parts of titanium oxide, 0.4 parts of carbon black, 7.0 parts of purified clay, 1.0 part of dioctyltin oxide and 20.87 parts of deionized water was dispersed in a ball mill for 20 hours and the paste thus formed was taken out from the ball mill as Pigment dispersed paste No. 1 having a solid content of 55%.

### Preparation Examples 2 to 11

### Pigment Dispersed Pastes No. 2 to No. 11

In a similar manner to that employed in Preparation Example 1 except that compositions shown in Table 1 were employed, respectively, pigment dispersed pastes No. 2 to No. 11 having a solid content of 55% were obtained.

TABLE 1
Composition of Pigment-dispersed Pastes

| | | Prep. | Prep. | Prep. | Prep. | Prep. | Prep. | Prep. | Prep. | Prep. | Prep. | Prep. |
|---|---|---|---|---|---|---|---|---|---|---|---|---|
| | | Ex. 1 | Ex. 2 | Ex. 3 | Ex. 4 | Ex. 5 | Ex. 6 | Ex. 7 | Ex. 8 | Ex. 9 | Ex. 10 | Ex. 11 |
| | | Pigment dispersed paste | | | | | | | | | | |
| | | No. 1 | No. 2 | No. 3 | No. 4 | No. 5 | No. 6 | No. 7 | No. 8 | No. 9 | No. 10 | No. 11 |
| Pigment | Epoxy quaternary ammonium | 5.83 | 5.83 | 5.83 | 5.83 | 5.83 | 5.83 | 5.83 | 5.83 | 5.83 | 5.83 | 5.83 |
| dispersing | type resin | (3.5) | (3.5) | (3.5) | (3.5) | (3.5) | (3.5) | (3.5) | (3.5) | (3.5) | (3.5) | (3.5) |
| resin | | | | | | | | | | | | |
| Corrosion | Cerium phosphate | 2 | | | | | | | | | | 5 |
| inhibitor (1) | Lanthanum oxide | | 2 | | | | | | | | | |
| | Magnesium molybdate | | | 2 | | | | 1 | 1 | | | |
| | Aluminum phosphomolybdate | | | | 2 | | | | | | | |
| | Tetracycline | | | | | 2 | | | | | | |
| | Magnesium L-ascorbyl | | | | | | 2 | | 1 | 1 | | |
| | phosphate | | | | | | | | | | | |
| | D-glucose | | | | | | | | | | | |
| | IXE-600 (*1) | | | | | | | 1 | | 1 | | |
| Coloring | Titanium oxide | 14.5 | 14.5 | 14.5 | 14.5 | 14.5 | 14.5 | 14.5 | 14.5 | 14.5 | 14.5 | 14.5 |
| pigment | Carbon black | 0.4 | 0.4 | 0.4 | 0.4 | 0.4 | 0.4 | 0.4 | 0.4 | 0.4 | 0.4 | 0.4 |
| Extender | Purified clay | 7 | 7 | 7 | 7 | 7 | 7 | 7 | 7 | 7 | 7 | 7 |
| pigment | | | | | | | | | | | | |
| Catalyst | Dioctyltin oxide | 1 | 1 | 1 | 1 | 1 | 1 | 1 | 1 | 1 | 1 | 1 |

| | | | | | | | | | | | |
|---|---|---|---|---|---|---|---|---|---|---|---|
| Deionized water | 20.87 | 20.87 | 20.87 | 20.87 | 20.87 | 20.87 | 20.87 | 20.87 | 20.87 | 20.87 | 23.4 |
| Solid content: 55% | 51.6 | 51.6 | 51.6 | 51.6 | 51.6 | 51.6 | 51.6 | 51.6 | 51.6 | 51.6 | 57.1 |
| | (28.4) | (28.4) | (28.4) | (28.4) | (28.4) | (28.4) | (28.4) | (28.4) | (28.4) | (28.4) | (31.4) |

(*1) “IXE-600” (trade name of Bi-Sb corrosion inhibitor, product of Toagosei, Co., Ltd.)

### Preparation Example 12

### Preparation of Xylene Formaldehyde Resin 1

In a separable flask having an internal capacity of 2 liters and equipped with a thermometer, a reflux condenser and a stirrer, 240 g of 50% formalin, 55 g of phenol, 101 g of 98% industrial sulfuric acid and 212 g of metaxylene were charged and they were reacted at from 84 to 88° C. for 4 hours. After completion of the reaction, the reaction mixture was allowed to stand to separate it into a resin phase and a sulfuric acid aqueous phase. The resin phase was washed three times with water, followed by stripping of unreacted metaxylene for 20 minutes under the conditions of from 20 to 30 mmHg and from 120 to 130° C., whereby xylene formaldehyde resin 1 having a viscosity of 1050 centipoise (at 25° C.) was obtained.

Preparation of Base Resin

### Preparation Example 13

### Preparation of Base Resin No. 1 (Base Resin (I) Type)

In a flask were added 1000 g of “EPIKOTE 828EL” (trade name; product of Japan Epoxy Resins Co., Ltd., epoxy equivalent: 190, molecular weight: 350), 400 g of bisphenol A and 0.2 g of dimethylbenzylamine and they were reacted at 130° C. until the epoxy equivalent became 750.

Next, 300 g of Xylene formaldehyde resin 1 obtained in Preparation Example 1, 140 g of diethanolamine and 65 g of ketimine-introduced diethylenetriamine were added, followed by reaction at 120° C. for 4 hours. To the reaction mixture was added 420 g of butyl cellosolve, whereby xylene-formaldehyde-resin-modified amino-containing epoxy resin having an amine number of 52 and a resin content of 80% was obtained as Base resin No. 1.

### Preparation Example 14

### Preparation of Base Resin No. 2 (Base Resin (I) Type)

To 400 g of “PP-400” (trade name of polypropylene glycol produced by Sanyo Chemical Industries, Ltd., molecular weight: 400) was added 300 g of ε-caprolactone and the mixture was heated to 130° C. Tetrabutoxytitanium (0.01 g) was then added and the mixture was heated to 170° C. While keeping this temperature, the reaction mixture was sampled time-dependently. The amount of the unreacted ε-caprolactone was traced by measuring infrared absorption spectrum and when the reaction ratio reached 98% or greater, the reaction mixture was cooled, whereby Modifier 1 was obtained.

In another flask, 1000 g of “EPIKOTE 828EL” (trade name of epoxy resin produced by Japan Epoxy Resins Co. Ltd., epoxy equivalent: 190, molecular weight: 350), 400 g of bisphenol A and 0.2 g of dimethylbenzylamine were added. They were reacted at 130° C. until the epoxy equivalent became 750.

Then, 200 g of Xylene formaldehyde resin 1 of Preparation Example 12, 100 g of Modifier 1, 140 g of diethanol and 65 g of ketimine-introduced diethylenetriamine were added. After reaction at 120° C. for 4 hours, 420 g of butyl cellosolve was added, whereby a xylene-formaldehyde-resin-modified amino-containing epoxy resin having an amine number of 52 and a resin content of 80% was obtained as Base resin No. 2.

### Preparation Example No. 15

### Base Resin No. 3 (Base Resin (II) Type)

To 400 g of “PP-400” (trade name of polypropylene glycol produced by Sanyo Chemical Industries, Ltd., molecular weight: 400) was added 300 g of ε-caprolactone and the mixture was heated to 130° C. Tetrabutoxytitanium (0.01 g) was then added and the mixture was heated to 170° C. While keeping this temperature, the reaction mixture was sampled time-dependently. The amount of the unreacted ε-caprolactone was traced by measuring infrared absorption spectrum and when the reaction ratio reached 98% or greater, the reaction mixture was cooled, whereby Modifier 2 was obtained.

In another flask, 1000 g of “EPIKOTE 828EL” (trade name of epoxy resin produced by Japan Epoxy Resins Co., Ltd., epoxy equivalent: 190, molecular weight: 350), 400 g of bisphenol A and 0.2 g of dimethylbenzylamine were added. They were reacted at 130° C. until the epoxy equivalent became 750.

After 200 g of Modifier 2, 140 g of diethanolamine and 65 g of ketimine-introduced diethylenetriamine were added to the reaction mixture and they were reacted at 120° C. for 4 hours, 400 g of butyl cellosolve was added, whereby a polyol-modified amino-containing epoxy resin having an amine number of 56 and a resin content of 80% was obtained as Base resin No. 3.

### Preparation Example 16

### Base Resin No. 4 (Base Resin (III) Type)

To 400 g of “PP-400” (trade name of polypropylene glycol produced by Sanyo Chemical Industries, Ltd., molecular weight: 400) was added 300 g of ε-caprolactone and the mixture was heated to 130° C. Tetrabutoxytitanium (0.01 g) was then added and the mixture was heated to 170° C. While keeping this temperature, the reaction mixture was sampled time-dependently. The amount of the unreacted ε-caprolactone was traced by measuring infrared absorption spectrum and when the reaction ratio reached 98% or greater, the reaction mixture was cooled, whereby Modifier 3 was obtained.

In another flask, 1000 g of “EPIKOTE 828EL” (trade name of epoxy resin produced by Japan Epoxy Resins Co., Ltd., epoxy equivalent: 190, molecular weight: 350), 400 g of bisphenol A and 0.2 g of dimethylbenzylamine were added. They were reacted at 130° C. until the epoxy equivalent became 750.

To the reaction mixture was added 120 g of nonylphenol and they were reacted at 130° C. until the epoxy equivalent became 1000. After 200 g of Modifier 3, 95 g of diethanolamine and 65 g of ketimine-introduced diethylenetriamine were added to the reaction mixture and they were reacted at 120° C. for 4 hours, 414 g of butyl cellosolve was added, whereby a nonylphenol-added polyol-modified amino-containing epoxy resin having an amine number of 40 and a resin content of 80% was obtained as Base resin No. 4.

### Preparation Example 17

### Base Resin No. 5 (Base Resin (III) Type)

To 1000 g of “EPIKOTE 828EL” (trade name of epoxy resin produced by Japan Epoxy Resins Co., Ltd., epoxy equivalent: 190, molecular weight: 350) were added 400 g of bisphenol A and 0.2 g of dimethylbenzylamine and the mixture was reacted at 130° C. until the epoxy equivalent became 750.

Benzoic acid (61 g) was then added to the reaction mixture and they were reacted at 130° C. until the epoxy equivalent became 1000.

After 200 g of Modifier 3 obtained as in Preparation Example 16, 95 g of diethanolamine and 65 g of ketimine-introduced diethylenetriamine were added to the reaction mixture and they were reacted at 120° C. for 4 hours, 400 g of butyl cellosolve was added, whereby a benzoic-acid-added polyol-modified amino-containing epoxy resin having an amine number 41 and a resin solid content of 80% was obtained as Base resin No. 5.

### Preparation Example 18

### Base Resin No. 6

In 546 parts of butyl cellosolve was dissolved 1900 parts of “EPON: 1004” (trade name of bisphenol A type epoxy resin having an epoxy equivalent of about 950, produced by Japan Epoxy Resins Co., Ltd.). After dropwise addition of 124 parts of diethylamine at 80 to 100° C., the reaction mixture was kept at 120° C. for 2 hours, whereby an epoxy-resin-amine adduct having an amine number of 47 was obtained.

Then, 1000 parts of a dimer acid type polyamide resin (“VERSAMID 460”, trade name; product of Henkel Hakusui Co., Ltd.) having an amine number of 100 was dissolved in 210 parts of methyl isobutyl ketone. The resulting solution was heated under reflux at 130 to 150° C. Water thus generated was distilled off and the terminal amino group of the amide resin was changed to ketimine. The resulting compound was maintained at 150° C. for about 3 hours. After termination of the distillation of water, the residue was cooled to 60° C. and added to the epoxy resin-amine adduct. The resulting mixture was heated to 100° C. After maintaining the mixture for 1 hour, it was cooled to room temperature, whereby an amino-containing epoxy resin, which is an epoxy-resin-amino-polyamide-added resin, having an amine number of 65 and a solid content of 80% was obtained as Base resin No. 6.

Preparation of Curing Agent

### Preparation Example 19

### Curing Agent No. 1

In a reaction vessel were charged 270 g of “COSMONATE M-200” (trade name) and 25 g of methyl isobutyl ketone. The resulting mixture was heated to 70° C. To the reaction mixture was added 15 g of 2,2-dimethylolbutanoic acid in portions, followed by the dropwise addition of 118 g of ethylene glycol monobutyl ether. After the mixture was reacted at 70° C. for 1 hour, it was cooled to 60° C. and 152 g of propylene glycol was added.

While keeping the temperature, sampling was conducted time-dependently. The disappearance of the absorption of unreacted isocyanate group was confirmed by infrared absorption spectrum, and Curing Agent No. 1 having a solid content of 90% was obtained.

### Preparation Example 20

### Preparation of Curing Agent No. 2

Curing Agent No. 2 having a solid content of 90% was obtained by the dropwise addition of 174 parts of methyl ethyl ketoxime at 50° C. to 222 parts of isophorone diisocyanate and 44 parts of methyl isobutyl ketone.

Preparation of Emulsion for Cationic Coating Composition

### Preparation Example 21

### Emulsion No. 1

After uniformly stirring a mixture of 87.5 parts (70 parts in terms of a resin content) of Base Resin No. 1, 33.3 g (30 g in terms of a resin content) of Curing Agent No. 1 and 13 parts of 10% acetic acid, deionized water was added dropwise in about 15 minutes while vigorously stirring the reaction mixture, whereby Emulsion No. 1 having a solid content of 34% was obtained.

### Preparation Examples 22 to 28

Emulsions No. 2 to No. 8 were obtained in a similar manner to that employed in Preparation Example 21 except that the composition was changed as shown in Table 2.

TABLE 2
Emulsion Composition

| | | Prep. Ex. | Prep. Ex. | Prep. Ex. | Prep. Ex. | Prep. Ex. | Prep. Ex. | Prep. Ex. | Prep. Ex. |
|---|---|---|---|---|---|---|---|---|---|
| | | 21 | 22 | 23 | 24 | 25 | 26 | 27 | 28 |
| | | Emulsion | | | | | | | |
| | | No. 1 | No. 2 | No. 3 | No. 4 | No. 5 | No. 6 | No. 7 | No. 8 |
| Composition | Base resin No. 1 (solid content: 80%) | 87.5 | | | | | 87.5 | | |
| | Xylene formaldehyde resin | (70) | | | | | (70) | | |
| | Base resin No. 2 (solid content: 80%) | | 87.5 | | | | | | |
| | Xylene formaldehyde resin | | (70) | | | | | | |
| | Base resin No. 3 (solid content: 80%) | | | 87.5 | | | | | |
| | Polyol-modified epoxy resin | | | (70) | | | | | |
| | Base resin No. 4 (solid content: 80%) | | | | 87.5 | | | | |
| | Nonyl-phenol-added polyol-modified | | | | (70) | | | | |
| | epoxy resin | | | | | | | | |
| | Base resin No. 5 (solid content: 80%) | | | | | 87.5 | | | |
| | Benzoic-acid-added polyol-modified | | | | | (70) | | | |
| | epoxy resin | | | | | | | | |
| | Base resin No. 6 (solid content: 80%) | | | | | | | 87.5 | 87.5 |
| | Amine-added epoxy resin | | | | | | | (70) | (70) |
| | Curing agent No. 1 (solid content: 90%) | 33.3 | 33.3 | 33.3 | 33.3 | 33.3 | 16.7 | 33.3 | 16.7 |
| | (Crude MDI-PG block) | (30) | (30) | (30) | (30) | (30) | (15) | (30) | (15) |
| | Curing Agent No. 2 (solid content: | | | | | | 16.7 | | 12 16.7 |
| | 90%) (IPDI-Ox) | | | | | | (15) | | (15) |
| | 10% acetic acid | 13 | 13 | 13 | 13 | 13 | 18 | 18 | 18 |
| | Deionized water | 160.2 | 160.2 | 160.2 | 160.2 | 160.2 | 160.2 | 160.2 | 160.2 |

| | | | | | | | | |
|---|---|---|---|---|---|---|---|---|
| 34% Emulsion | 294 | 294 | 294 | 294 | 294 | 294 | 294 | 294 |
| | (100) | (100) | (100) | (100) | (100) | (100) | (100) | (100) |

### Examples and Comparative Examples

### Example 1

To 297 parts (solid content: 100 parts) of Emulsion No. 1 (Base Resin No. 1, Curing Agent No. 1) were added 51.6 parts (solid content: 28.4 parts) of Pigment-dispersed paste No. 1 and 294 parts of deionized water to prepare Cationic Coating No. 1 having a solid content of 20%.

### Examples 2 to 9, and Comparative Examples 1 to 4

In a similar manner to Example 1 except for the use of the compositions as shown in Table 3 or Table 4 instead, Cationic Coatings No. 2 to No. 9 of Examples 2 to 9 and Cationic Coatings No. 10 to No. 13 of Comparative Examples 1 to 4 were prepared. The details of the composition are shown in Table 3 (Examples) and Table 4 (Comparative Examples).

TABLE 3
Composition of cationic coatings (Examples)

| | Ex. 1 | Ex. 2 | Ex. 3 | Ex. 4 | Ex. 5 | Ex. 6 | Ex. 7 | Ex. 8 | Ex. 9 |
|---|---|---|---|---|---|---|---|---|---|
| | Cationic coating | | | | | | | | |
| | No. 1 | No. 2 | No. 3 | NO. 4 | NO. 5 | No. 6 | No. 7 | No. 8 | No. 9 |
| Emulsion No. 1 (Base resin No. 1, Curing agent No. 1) | 297 | | | | | | | | |
| Emulsion No. 2 (Base resin No. 2, Curing agent No. 1) | | 297 | | | | | | | |
| Emulsion No. 3 (Base resin No. 3, Curing agent No. 1) | | | 297 | | | | | | |
| Emulsion No. 4 (Base resin No. 4, Curing agent No. 1) | | | | 297 | | | | | |
| Emulsion No. 5 (Base resin No. 5, Curing agent No. 1) | | | | | 297 | | | | |
| Emulsion No. 6 (Base resin No. 1, Curing agent No. 1/No. 2) | | | | | | 297 | | | |
| Pigment-dispersed paste No. 1 cerium phosphate | 51.6 | | | | | | | | |
| Pigment-dispersed paste No. 2 lanthanum oxide | | 51.6 | | | | | | | |
| Pigment-dispersed paste No. 3 Mg molybdate | | | 51.6 | | | | | | |
| Pigment-dispersed paste No. 4 aluminum phophomolybdate | | | | 51.6 | | | | | |
| Pigment-dispersed paste No. 5 tetracycline | | | | | 51.6 | | | | |
| Pigment dispersed paste No. 6 Mg ascorbyl phosphate | | | | | | 51.6 | | | |
| Pigment-dispersed paste No. 7 magnesium molybdate - IXE | | | | | | | 51.6 | | |
| Pigment-dispersed paste No. 8 Mg molybdate - Mg ascorbate | | | | | | | | 51.6 | |
| Pigment-dispersed paste No. 9 Mg ascorbate - IXE | | | | | | | | | 51.6 |
| Deionized water | 293.4 | 293.4 | 293.4 | 293.4 | 293.4 | 293.4 | 293.4 | 293.4 | 293.4 |
| 20% Cationic coating | 642 | 642 | 642 | 642 | 642 | 642 | 642 | 642 | 642 |

TABLE 4
Composition of Cationic Coating
(Comparative Examples)

| | Comp. | Comp. | Comp. | Comp. |
|---|---|---|---|---|
| | Ex. 1 | Ex. 2 | Ex. 3 | Ex. 4 |
| | Cationic coating | | | |
| | No. 10 | No. 11 | No. 12 | No. 13 |
| Emulsion No. 7 (Base resin No. 6, | 297 | 297 | | 297 |
| Curing agent No. 1) | | | | |
| Emulsion No. 8 (Base resin No. 6, | | | 297 | |
| Curing agent No. 1/No. 2) | | | | |
| Pigment-dispersed paste No. 3 | 51.6 | | | |
| Mg molybdate | | | | |
| Pigment-dispersed paste No. 10 | | 51.6 | 51.6 | |
| Pigment-dispersed paste No. 11 | | | | 57.1 |
| cerium phosphate (amount | | | | |
| increased) | | | | |
| Deionized water | 293.4 | 293.4 | 293.4 | 302.9 |
| 20% Cationic coating | 642 | 642 | 642 | 657 |

Test on Coating Film

Each of a cold rolled steel sheet of 70 mm×150 mm and an aluminum sheet (#6000) of 70 mm×150 mm was subjected to chemical conversion treatment with “PB-LA-35” (trade name of a chemical solution capable of processing aluminum and steel sheet simultaneously, product of Nihon Parkerizing Co., Ltd.). Cationic Coatings No. 1 to No. 13 were each applied to the resulting sheet to give a film thickness of 20 μm, followed by baking at 170° C. for 20 minutes. Tests on coating film were each made in the below-described manner. The results of Examples are shown in Table 5, while those in Comparative Examples are shown in Table 6.

TABLE 5
Performances of coating films (Examples)

| | | Example 1 | Example 2 | Example 3 | Example 4 | Example 5 | Example 6 | Example 7 | Example 8 | Example 9 |
|---|---|---|---|---|---|---|---|---|---|---|
| | | Cationic coating | | | | | | | | |
| | | No. 1 | No. 2 | No. 3 | No. 4 | No. 5 | No. 6 | No. 7 | No. 8 | No. 9 |
| Salt spray | Cold rolled steel sheet | B | B | B | B | B | B | A | A | A |
| resistance *2 | Aluminum material | B | B | B | B | B | B | A | A | A |
| Hot-salt- | Cold rolled steel sheet | B | B | B | B | B | B | A | A | A |
| water immersion | Aluminum material | B | B | B | B | B | B | A | A | A |
| resistance *3 | | | | | | | | | | |
| Exposure | Cold rolled steel sheet | B | B | B | B | B | B | A | A | A |
| corrosion | Aluminum material | B | B | B | B | B | B | A | A | A |
| resistance *4 | | | | | | | | | | |
| Finish property | Cold rolled steel sheet | A | A | A | A | A | A | A | A | A |
| (horizontal | | | | | | | | | | |
| surface) *5 | | | | | | | | | | |

TABLE 6
Performance of coating films (Comparative Examples)

| | | Comparative | Comparative | Comparative | Comparative |
|---|---|---|---|---|---|
| | | Example 1 | Example 2 | Example 3 | Example 4 |
| | | No. 10 | No. 11 | No. 12 | No. 13 |
| Salt spray resistance *2 | Cold rolled steel sheet | B | C | D | B |
| | Aluminum material | B | C | C | B |
| Hot-salt-water immersion resistance *3 | Cold rolled steel sheet | B | D | D | B |
| | Aluminum material | B | C | C | B |
| Exposure corrosion resistance *4 | Cold rolled steel sheet | D | D | C | B |
| | Aluminum material | C | C | C | C |
| Finish property (horizontal surface) *5 | Cold rolled steel sheet | A | A | A | C |
| (*2) Salt spray resistance: A test plate was crosscut by a cutter knife and salt spray test at 35° C. was conducted for 840 hours. The sheet was subjected to tape peeling for evaluation. | | | | | |
| A: a width peeled by the tape is less than 2 mm (on one side) | | | | | |
| B: a width peeled by the tape is 2 mm or greater but less than 3 mm (on one side) | | | | | |
| C: a width peeled by the tape is 3 mm or greater but less than 4 mm (on one side) | | | | | |
| D a width peeled by the tape is 4 mm or greater (on one side). | | | | | |
| (*3): Resistance against hot salt water immersion: A test plate was immersed in salt water of 50° C. After 480 hours test, the whole surface of the steel sheet was subjected to tape peeling and evaluated. | | | | | |
| A: A percentage of the coating film peeled by the tape is less than 5% of the whole area of the sheet. | | | | | |
| B: A percentage of the coating film peeled the tape is less than 10% of the whole area of the sheet. | | | | | |
| C: A percentage of the coating film peeled by the tape is from 10% to 20% of the whole area of the sheet | | | | | |
| D: A percentage of the coating film peeled by the tape exceeds 20%. | | | | | |
| (*4) Exposure corrosion resistance: An intermediate coating “TP-65-2” was applied to each test plate to give a film thickness of 35 μm, followed by baking at 140° C. for 20 minutes. Then, “NEOAMYLAC 6000 (white)” was applied to give a thickness of 35 μm, | | | | | |
| # followed by baking at 140° C. for 20 minutes. The resulting plate was crosscut by a cutter knife and subjected to exposure test for 1 year in Chikura-cho (Chiba Prefecture). | | | | | |

A: The width of rust or blister from the cut line is less than 2 mm (on one side)
B: The width of rust or blister from the cut line is from 2 mm to less than 3 mm (on one side)
C: The width of rust or blister from the cut line is from 3 mm to less than 4 mm (on one side)
D: The width of rust or blister from the cut line exceeds 4 mm (on one side)
(*5) Finish property (horizontal surface): Each cationic coating was filled in a test tank and it was applied horizontally to a chemically processed cold rolled sheet under the conditions to give a film thickness of 20 μm. After washing with water, it was baked at 170° C. for 20 minutes and surface condition was observed.
A: good without luster loss, seeding, cissing and cratering.
B: lowering in finish property owing to luster loss, seeding, cissing and cratering is observed.
C: considerable lowering in the finish property owing to luster loss, seeding, cissing and cratering is observed.

The disclosure of Japanese Patent Application No. 2002-370954 filed on Dec. 20, 2002 including specifications, drawings and claims is incorporated herein by reference in its entirety.

1. A coating composition used for coating of a steel material and/or aluminum material, comprising:
at least one corrosion inhibitor selected from corrosion inhibitors of cerium compounds, lanthanum compounds, molybdate salt compounds, gluconic acid derivative salts, porous base materials, triazole compounds, thiazole compounds, tetracyclines, and metal phosphate salt compounds of ascorbic acid; a base resin; and a curing agent; wherein,
the base resin is selected from the group consisting of
(A) a base resin (I), which is a xylene-formaldehyde-resin-modified amino-containing epoxy resin obtained by reacting an epoxy resin (1) having an epoxy equivalent of from 180 to 2500 with a xylene formaldehyde resin (2) and an amino-containing compound (3),
(B) base resin (II), which is a polyol-modified amino-containing epoxy resin obtained by reacting an epoxy resin (1) having an epoxy equivalent of from 180 to 2500 with a polyol compound (4) available by adding a caprolactone to a compound containing a plurality of active hydrogen groups and an amino-containing compound (3), and
(C) a base resin (III), which is a polyol-modified amino-containing epoxy resin (III) obtained by reacting an epoxy resin (1) having an epoxy equivalent of from 180 to 2500 with an alkyl phenol (v₁) and/or a carboxylic acid (v₂), a polyol compound (4) available by adding a caprolactone to a compound having a plurality of active hydrogen groups, and an amino-containing compound (3).

2. A coating composition according to claim 1, wherein the curing agent is a curing agent (I), which is a blocked polyisocyanate compound obtained by blocking an isocyanate group of a polyisocyanate compound with a blocking agent.

3. A coating composition according to claim 1, wherein the curing agent is a block polyisocyanate curing agent (II) obtained by reacting an active-hydrogen-containing component containing propylene glycol with an aromatic polyisocyanate is contained as the curing agent of the coating composition.

4. A coating composition according to claim 1, wherein the coating composition is a cationic electrodeposition coating.

5. An article coated with the coating composition as claimed in claim 1.

6. An article coated with the coating composition as claimed in claim 2.

7. An article coated with the coating composition as claimed in claim 3.

8. An article coated with the coating composition as claimed in claim 4.
